(19) United States
(12) Patent Application Publication
(10) Pub. No.: US 2002/0083639 A1
(43) Pub. Date: Jul. 4, 2002

(54) Trap and monitoring system for controlling rests

(76) Inventor: Clint Perry, Evansville, IN (US)

Correspondence Address: GARY K. PRICE, 111 S.E. THIRD STREET, SUITE 201, EVANSVILLE, IN, 47708-1431, US

(21) Appl. No.: 10/034,787

(22) Filed: Dec. 27, 2001

Related U.S. Application Data
(60) Provisional application No. 60/258,830, filed on Dec. 28, 2000.

(51) Int. Cl. A01M 1/14

(52) U.S. Cl. 43/114

(57) ABSTRACT

A trap and monitoring system for controlling pests, which system comprises generally of two sections, a back panel that attaches to a front housing forming the system. Said front housing having openings sized to permit the pest to pass through the openings so that the pest can gain access to the interior of the system. Disposed within the front housing is a tubular member having a sticky substance thereon that lures pests to the tubular member and traps the pests upon contact.

### CROSS REFERENCES TO RELATED APPLICATIONS

U.S. Provisional Application for Patent 6/258,830, filed Dec. 28, 2000, with title, “Method and Apparatus for Monitoring and/or Controlling Pests” which is hereby incorporated by reference. Applicant claims priority pursuant to 35 U.S.C. ¶119(e)(i).

Statement as to rights to inventions made under Federally sponsored research and development:

Not Applicable

### BACKGROUND OF THE INVENTION

1. Field of the Invention

This invention relates generally to a trap and monitoring system for controlling pests, as might be particularly useful for monitoring and/or controlling flying insects such as flies, by enhancing the likelihood that such pests will be positively attracted to the apparatus, and then trapping the pests.

2. Background Information

It has been known to employ pest control systems in efforts to control pests. One such system is commonly referred to as a bait station, which generally is an enclosure having at least one tray therein, which tray holds poison liquid or granulds, attractant or repellent for pests that enter the enclosure. However, existing bait stations are unattractive, do not blend in with the environment, and often expose the “captured” pests to the general public. Thus, their use is limited in some locations because of their unsightly appearance which often draws attention to the fact there is a pest control problem. Further, existing bait stations are often difficult to clean and maintain, and/or replace the bait therein. Such bait stations again give a relatively unsanitary appearance. This is especially a problem at food serving locations.

Another common system is a sticky or glue trap where an elongated sticky strip extends usually from the ceiling of a structure and “catches” any pests that come in contact with the strip. Again, this type of trap exposes the captured pests to the general public, gives a relatively unsanitary appearance, especially at food serving locations.

As will be seen from the subsequent description, the preferred embodiment of the present invention overcomes these and other shortcomings of prior art.

### SUMMARY OF THE INVENTION

The present invention is a trap and monitoring system for controlling pests. The system disclosed within the present invention is adapted to be hidden so that the general public sees neither the bait or the captured pests. Generally, the system comprises an enclosure having a back panel, and a front housing formed of a front panel, side panels, a bottom front panel, and a top panel. The front housing has at least one aperture allowing pests to access the interior of the system. The size of said aperture may be limited to the size of the pest intended to enter the interior. The interior of the system comprising a tubular member that has on its exterior surface a sticky substance that lures pests to the tubular member and traps the pests to the tubular member upon contact. The tubular member may further contain various scented granulds affixed thereon to further lure the pests into the station.

The present invention will be more fully understood upon reading the following detailed description of the preferred embodiments in conjunction with the accompanying drawings.

### BRIEF DESCRIPTION OF THE DRAWINGS

FIG. 1 illustrates a perspective view of a preferred embodiment of the present invention, namely a trap and monitoring system for controlling pests.

FIG. 2 illustrates a perspective view of the system of FIG. 1 showing the back housing and the interior of the system.

FIG. 3 illustrates a sectional perspective view of the system of FIG. 1.

FIG. 4 illustrates a perspective view of the tubular member of the system of FIG. 1.

FIG. 5 illustrates a perspective view of the exterior side of the front housing of the system of FIG. 1.

FIG. 6 illustrates a perspective view of the interior side of the front housing of the system of Fig.

FIG. 7 illustrates a perspective view of the side roller members of the system of FIG. 1

FIG. 8 illustrates a perspective view of the interior side of the back panel of the system of FIG. 1.

FIG. 9 illustrates the interior side of the bottom front panel of the system of FIG. 1.

FIG. 10 illustrates the exterior side of the bottom front panel of the system of FIG. 1.

FIG. 11 illustrates a perspective view of the exterior side of the side panel of the system of FIG. 1.

FIG. 12 illustrates a perspective view of the interior side of the side panel of the system of FIG. 1.

FIG. 13 illustrates an exploded perspective view of the system of FIG. 1 showing its back panel.

FIGS. 14 and 15 illustrate placement of the system of FIG. 1 to a structure.

### DESCRIPTION OF THE PREFERRED EMBODIMENTS

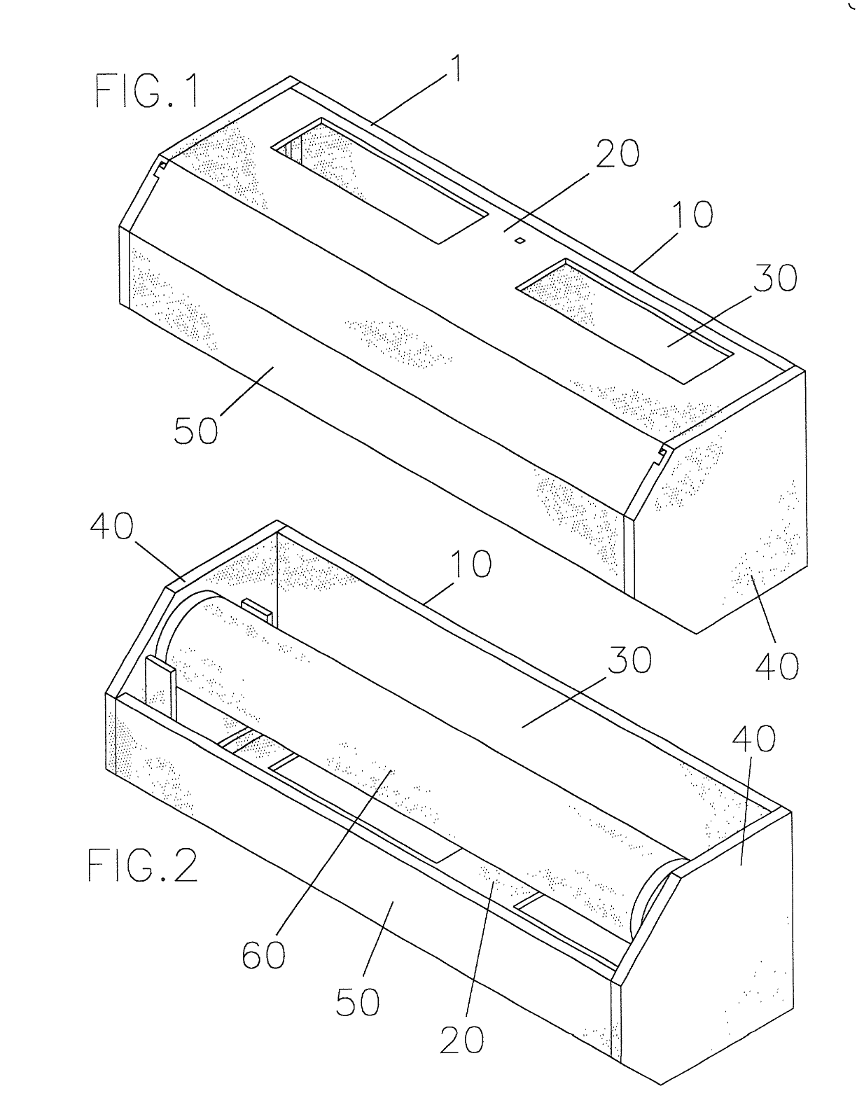

FIGS. 1-13 illustrate a preferred embodiment of a trap and monitoring system 1 for controlling pests, in accordance with the present invention. The system 1 has particular utility for use in monitoring and controlling pests by incorporating a tubular member 60 that has on its exterior surface, a sticky substance 61 (shown in FIG. 4) that lures pests to the tubular member 60 and traps the pests to the tubular member 60 upon contact.

System 1 comprises generally of two sections, which when attached together form said system 1. The said system'1 two sections are typically made so that the two sections can simply be attached together. As best shown in FIGS. 5, and 11-12, system 1 includes a front housing 20, formed of a front panel 22, a top panel 21, side panels 40, and a bottom front panel 50. The front housing 20 comprising the top panel 21, the side panels 40, and the bottom front panel 50, is attached to the back panel 30 to form system 1.

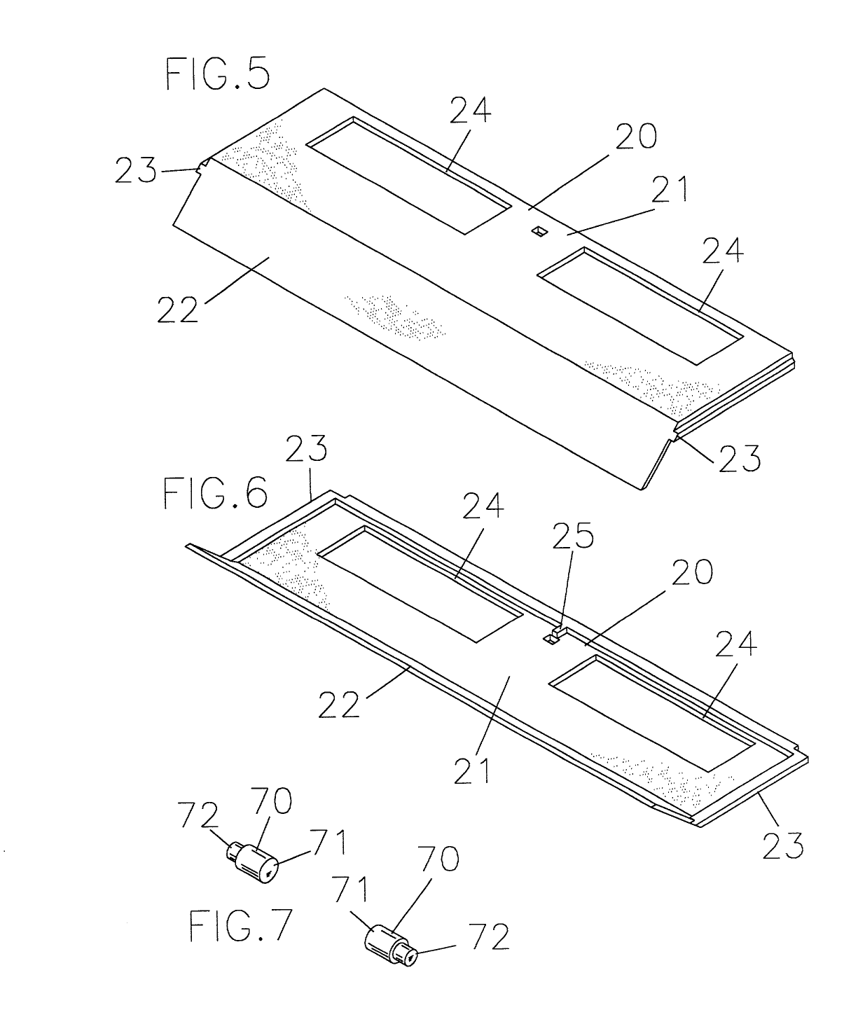

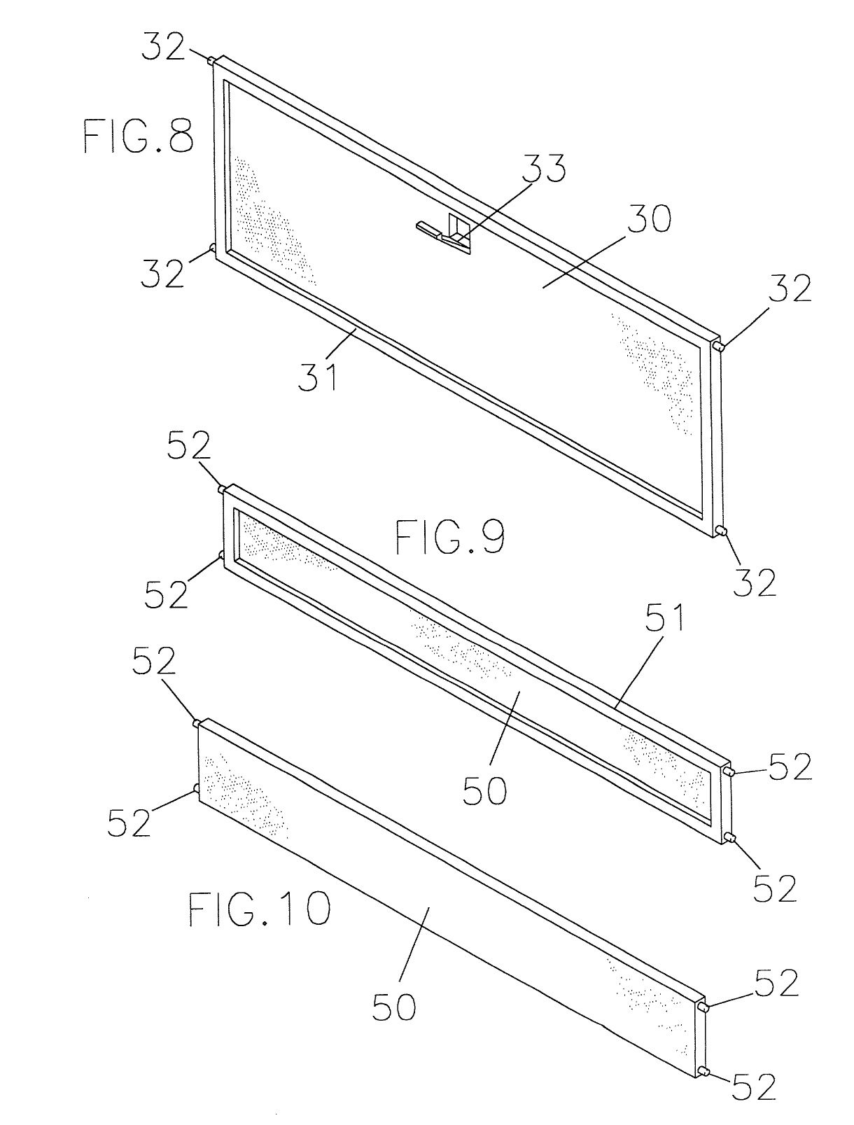

As shown in FIGS. 5-6, the top panel 21 of the front housing 20 includes at least one aperture 24 to allow pests access to the interior of the system 1 from a location outside the system 1. The size of the aperture 24 may be limited to the size of the pest intended to enter the interior. The front housing 20 further includes side mounting lips 23, and a clip stop 25 located on the interior side of the top panel 21. As shown in FIG. 4, the tubular member 60 includes ends 62, each end 62 having a member aperture 63. As shown in FIGS. 9-10, the bottom front panel 50 includes a ridge 31, a clip 33, and on each corner, a radially outwardly extending post 52. As shown in FIG. 8, the back panel 30 includes a ridge 31, a clip 33, and on each corner, a radially outwardly extending post 32.

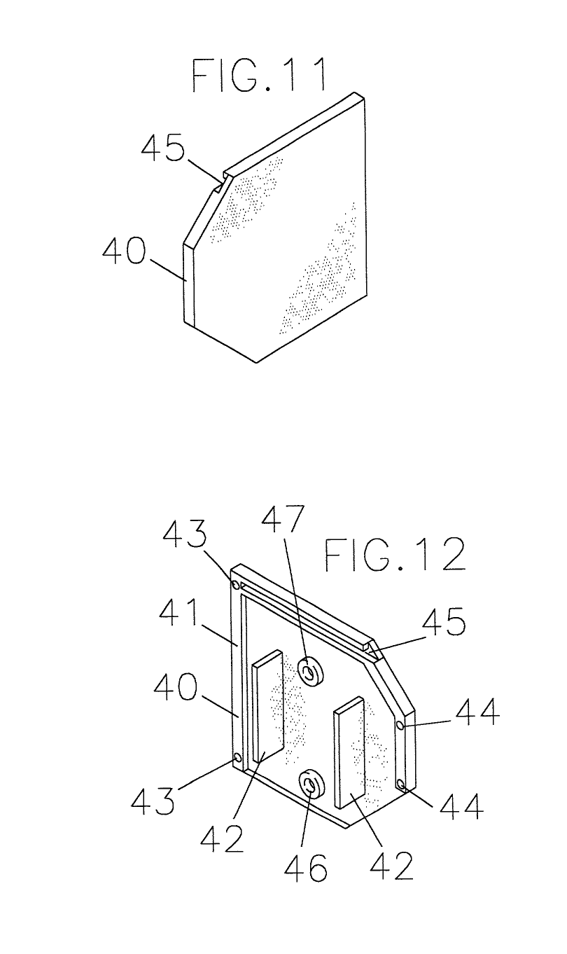

Referring to FIGS. 11-12, the side panels 40 each include a pair of spacers 42, said spacers 42 vertically parallel to the other, and in sufficient spaced apart relationship to receive the tubular member 60 therebetween. Each of said side panels 40 further include a pair of back pin apertures 43 sized to receive the extending posts 32 of the back panel 30, and a pair of bottom pin apertures 44 sized to receive the extending posts 52 of the bottom front panel 50, a groove 45 aligned parallel with the top edge of the side panel 40, and as shown in FIG. 12, a first and second side aperture 46, 47. Said first side aperture 46 in vertical alignment with said second aperture 47. The system 1 further includes a pair of side roller members 70. As shown in FIG. 7, said side roller members 70 having a first cylindrical end 71 and a second cylindrical end 72. Said first cylindrical end 71 sized to be received by the member aperture 63 of the tubular member 60. Said second cylindrical end 72 sized to be selectively received by either the aperture 46 or 47 of the side panels 40. Said first and second side apertures 46, 47 are used to selectively position the tubular member 60 to a first position within the system 1 by mounting the tubular member 60 to the apertures 46 on each of the side panels 40, or a second position within the system 1 by mounting the tubular member 60 to the apertures 47 on each of the side panels 40.

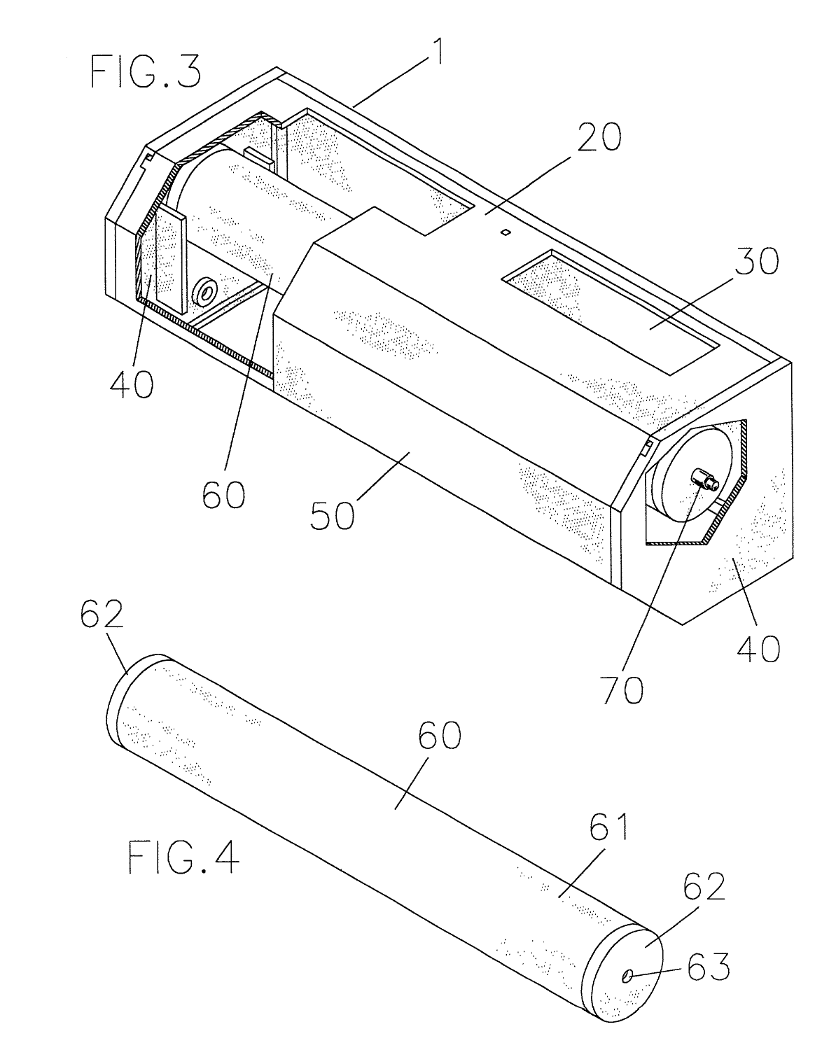

As shown in FIG. 3, the tubular member 60 is removable, and horizontally situated inside the system 1, exposing the sticky substance layer 61 that lures pests to the tubular member 60 and traps the pests on the tubular member 60 upon contact. The sticky substance layer 61 is affixed to the tubular member 60 and a part of the interior of the system 1.

The extending posts 32 of the back panel 30 slidably fit within the back pin apertures 43 of the side panels 40; the grooves 45 of the side panels 40 are shaped and sized to receive the side mounting lips 23 of the front housing 20; and, the extending posts 52 of the bottom front panel 50 slidably fit within the bottom pin apertures 44 of the side panels 40. Locking the clip 33 of the back panel 30 to the clip stop 25 of the front housing 20 releasably locks the front housing 20 to the back panel 30 forming the system 1.

To assemble the front housing 20, the extending posts 52 of the bottom front panel 50 slidably fit within the bottom pin apertures 44 of the side panels 40; and, the mounting lips 23 of the front housing 20 are slidably received by the groves 45 of the side panels 40. The tubular member 60 is installed within the front housing 20 by first inserting the first cylindrical end 71 of the side roller member 70 into the member aperture 63 of each of the ends 62 of the tubular member 60, then upwardly sliding the tubular member 60 between the spacers 42 of the side panels 40, and inserting the second cylindrical end 72 of the side roller member 70 into either the first or second side apertures 46, 47 on each of the side panels 40. Then, then extending posts 32 of the back panel 30 slidably fit within the back pin apertures 43 of the side panels 40 and, the clip 33 of the back panel 30 is fastened to the clip stop 25 of the front housing 20.

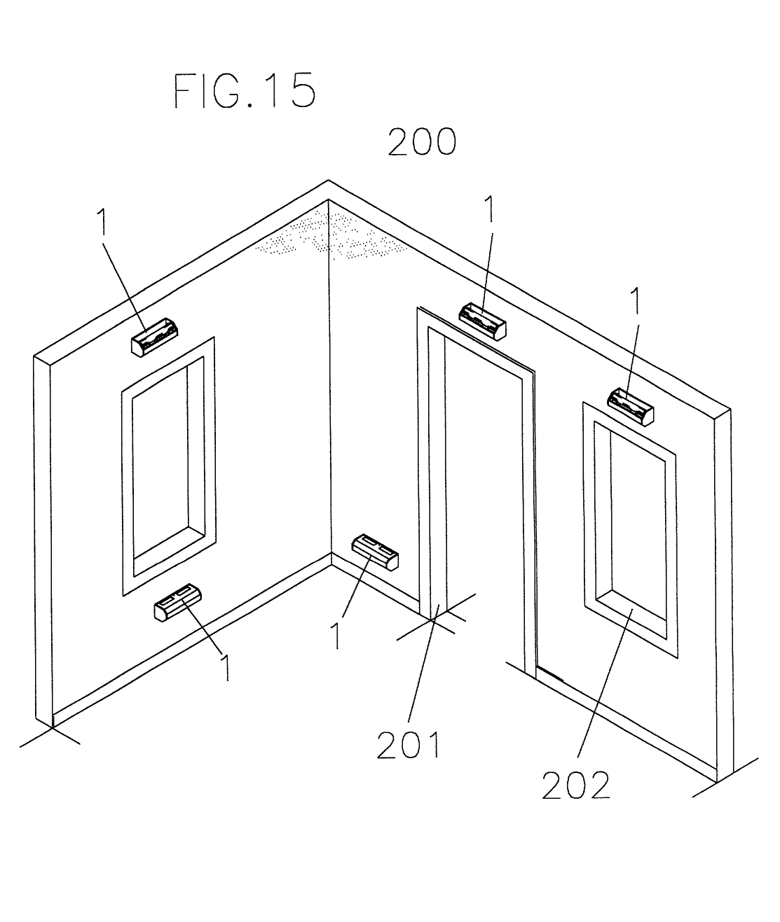

The system 1 may be mounted to either the outside of a structure 100 as shown in FIG. 14, or inside of a structure 200 as shown in FIG. 15. Referring to FIG. 15, the system 1 may be placed at various locations inside the structure 200 where pests are likely to be found, including above a window 202, or near a doorway 201. Of concern when mounting the system 1 inside the structure 200, is to avoid mounting the system 1 so that the general public is exposed to the captured pests within the system 1. When mounting at lower heights, the system 1 may be mounted with the top panel 21 facing upwardly as shown in FIG. 15. As such, the general public is less likely to view the tubular member 60 within the system 1. When mounting the system 1 at higher heights, the system 1 may be mounted with the top panel 21 facing downwardly as shown above the doorway 201 and above the window 202 in FIG. 15, in order to “hide” the tubular member 60 from the general public.

Likewise, when the system 1 is mounted to the outside of the structure 100, as shown in FIG. 14, the system 1 may be placed at various locations outside the structure 100 where pests are likely to be found, including adjacent to a trash container 101. As further shown in FIG. 14, when mounting the system 1 to the outside of the structure 100, it is preferred that the top panel 21 face upwardly in order to best shield the interior of the system 1 from inclement weather.

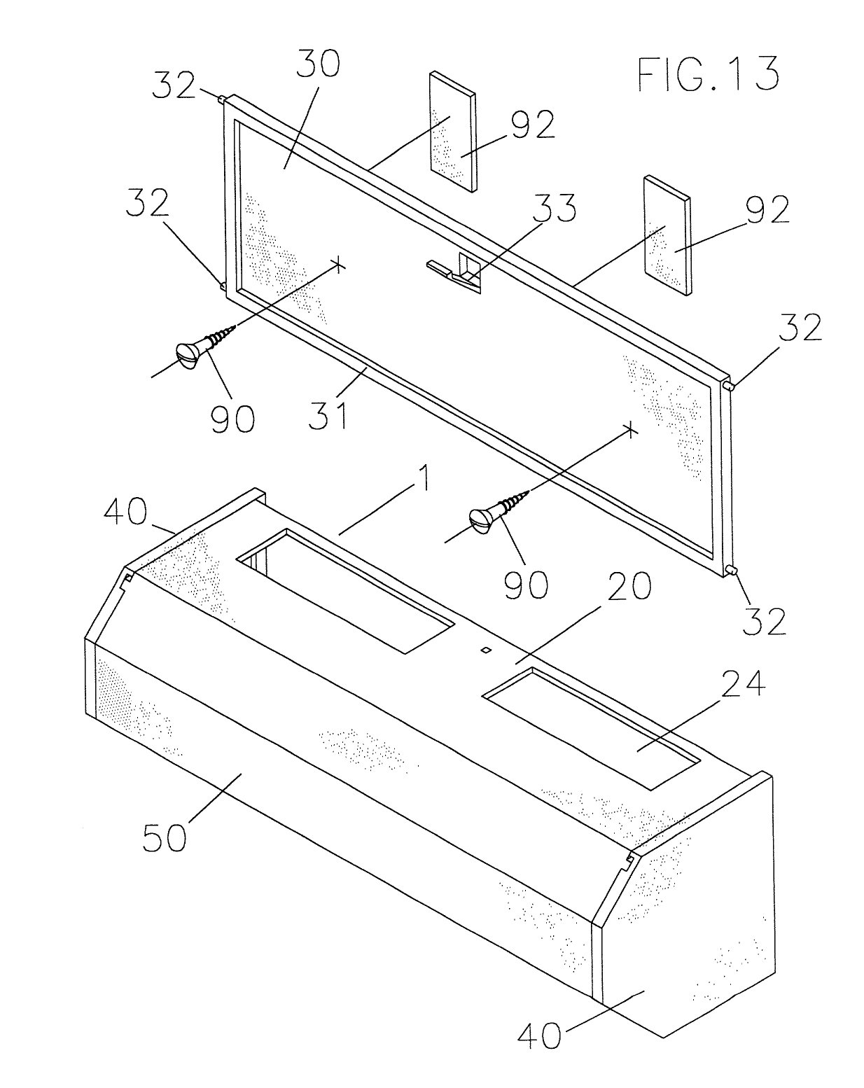

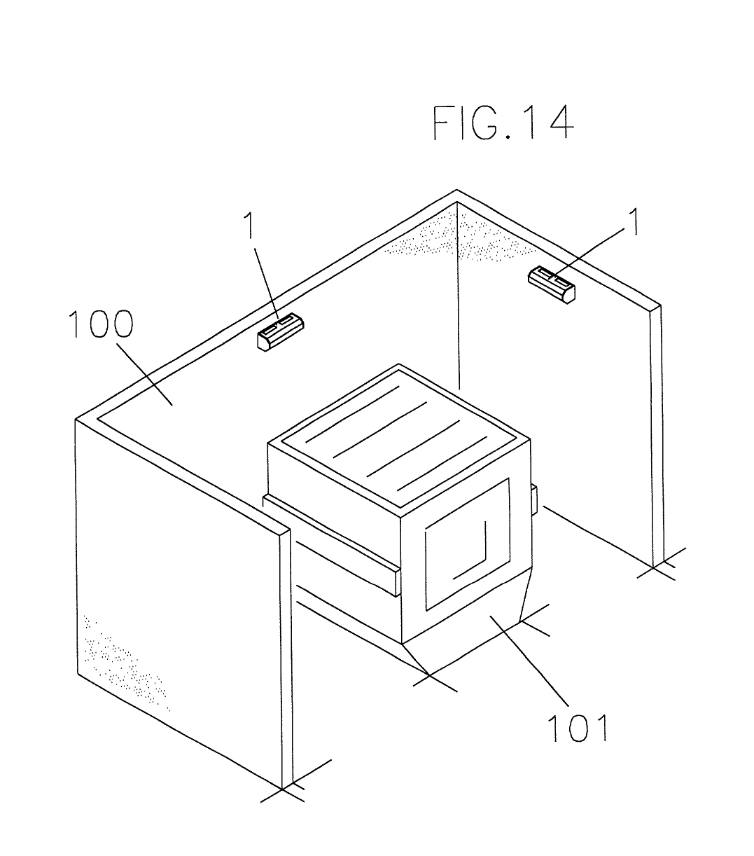

Referring now to FIG. 13, the system 1 is mounted by attaching the back panel 30 to the structure 100 or 200 (not shown in FIG. 13) using a double-face tape 92 between the rear side of the back panel 30 and the structure, or drilling common wood screws or concrete screws 90, or other type anchoring device, known in the art, through the back panel 30 into the structure 100, 200. Once the back panel 30 is attached to the structure 100, 200, the side panels 40 of the assembled front housing 20 is attached to the back panel 30 by inserting the extending posts 32 of the back panel 30 within the back pin apertures 43 of the side panels 40, and locking the clip 33 of the back panel 30 to the clip stop 25 of the front housing 20.

In operation, the tubular member 60 will need to be periodically replaced. To replace the tubular member 60, the operator releases the clip 33 of the back panel 30 from the clip stop 25 of the front housing 20, and disengage the extending posts 32 of the back panel 30 from the back pin apertures 43 of the side panels 40. Upon release, the front housing 20 separates from the back panel 30 allowing easy access to the tubular member 60. The tubular member 60 is removed from the interior of the system 1 by releasing the second cylindrical end 72 from the side apertures 46 or 47 of the side panels 40. The replacement tubular member 60 is then installed within the system 1 by first inserting the first cylindrical end 71 of the side roller members 70 into the member aperture 63 of the tubular member 60, and then inserting the second cylindrical end 72 into either the first or second side apertures 46, 47 on each of the side panels 40.

Although the description above contains some specificities, these should not be construed as limiting the scope of the invention but as merely providing illustrations of some of the presently preferred embodiments of this invention. Thus the scope of the invention should be determined by the appended claims in the formal application and their legal equivalence, rather than by the examples given.

I claim:

1. A trap and monitoring system for controlling pests, comprising:
a front housing, including a front panel, a top panel, a first and second side panels, and a bottom front panel;
a back panel that attaches to the first and second side panels of the front housing, said back panel defining front and back surfaces, wherein the back surface attaches to a structure;
a tubular member having an exterior surface, said tubular member is horizontally received inside the front housing between the first and second side panels; and mounting means to attach the back panel to the structure;
wherein said first and second side panels each having first and second apertures adapted to removably receive the tubular member for selectively positioning the tubular member inside the system.

2. The trap and monitoring system as recited in claim 1, wherein each of the first and second side panels have a pair of spacers in vertically-parallel, spaced apart relationship to receive the tubular member.

3. The trap and monitoring system as recited in claim 1, wherein the exterior surface of the tubular member is a sticky substance that lures the pests to the tubular member and traps the pests on the tubular member upon contact.

4. The trap and monitoring system as recited in claim 1, further comprising locking means so that the front housing is releasably locked to the back panel.

5. The trap and monitoring system as recited in claim 1, wherein the top panel comprises openings sized to permit the pests to pass through the openings.

6. A trap and monitoring system for controlling pests, comprising:
a housing having openings sized to permit the pests to pass through the openings so that the pests can gain access to the interior of the housing from a location outside the housing; and
a tubular member having an exterior surface, said tubular member removably disposed within the housing.

7. The trap and monitoring system of claim 6, wherein the exterior surface of the tubular member is a sticky substance that lures the pests to the tubular member and traps the pests on the tubular member upon contact.

8. A method for trapping, monitoring, or controlling pests comprising the steps of:
providing a station comprising:
(a) a housing having openings sized to permit the pests to pass through the openings so that the pests can gain access to the interior of the housing from a location outside the housing; and
(b) a tubular member having an exterior surface, said tubular member removably disposed within the housing.

9. The method as recited in claim 8, wherein the exterior surface of the tubular member is a sticky substance that lures the pests to the tubular member and traps the pests on the tubular member upon contact.
